(19) United States
(12) Patent Application Publication
(10) Pub. No.: US 2026/0227221 A1
(43) Pub. Date: Aug. 6, 2026

(54) FLUID LEVEL MONITORING SYSTEM FOR DISHWASHING MACHINES

(71) Applicant: Ecolab USA Inc., Saint Paul, MN (US)

(72) Inventors: Zhenfeng Dou, Pudong (CN); Mingyue Zhao, Pudong (CN); Shuchen Zhou, Shanghai (CN)

(21) Appl. No.: 19/154,126

(22) PCT Filed: Feb. 28, 2023
(86) PCT No.: PCT/CN2023/078583

§ 371 Date: Aug. 6, 2025

(51) Int. Cl. G01F 23/24; A47L 15/42

(52) U.S. Cl. CPC G01F 23/24; A47L 15/4246; A47L 15/4297

(57) ABSTRACT

A fluid detection system for a dishwashing machine can include a tank adapted to hold a fluid during a cleaning cycle the tank adapted to function as an electrical ground, a probe including a first electrode positioned to contact the fluid within the tank when the fluid is at a first fluid level, a second electrode positioned to contact the fluid within the tank when the fluid is at a second fluid level, and a mounting flange adapted to be secured to a first vertical wall or a second vertical wall of the tank; and, a control circuit adapted to provide alternating current to the probe, and, based on a signal from the first electrode or the second electrode, cause fluid to be pumped into the tank or to be drained from the tank during a cleaning cycle.

### TECHNICAL FIELD

The disclosure of the present application pertains generally, but not by way of limitation, to systems and techniques for monitoring fluid levels within a tank or reservoir. More particularly, but not by way of limitation, the disclosure of the present application pertains to systems and techniques for monitoring fluid levels within a tank or reservoir of a dishwashing machine using conductivity probes.

### BACKGROUND

Dishwashing machines include at least one subsystem for maintaining fluid levels within a tank adapted for holding dishes during a wash cycle. Such subsystems are typically designed to sense a fluid level within the tank to control the inflow of fluid into the tank at the start of a wash cycle, such as by activating a pump adapted to fill the tank, and control the outflow of fluid from the tank, such as by disabling the pump, activating another pump adapted to drain the tank, or opening a valve adapted to enable fluid to flow out of the tank. In this way, such subsystems can ensure fluid levels within the tank remain between an uppermost or maximum level, and a lowermost or minimum level, during a wash cycle.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 illustrates a perspective view of a fluid level monitoring system.

FIG. 2A illustrates a side view of a tank holding a fluid at a first level.

FIG. 2B illustrates a side view of a tank holding a fluid at a second level.

FIG. 3 illustrates a schematic diagram of a fluid level monitoring system.

FIGS. 4A-4D illustrate various views of an example dishwashing machine in which the fluid monitoring system of FIGS. 1-3 can be used.

FIG. 5 illustrates an example of the dishwashing machine of FIGS. 4A-4D with accessories.

FIG. 6 illustrates an example hydraulic system of the dishwashing machine of FIGS. 4A-5.

FIG. 7 illustrates a method of replacing a level switch of a dishwashing machine.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

As used in the present disclosure, a “dishwasher” (also known as dish washing machine, warewasher, or warewashing machine) can include any type of washing machine that can use detergent for cleaning and/or sanitizing purposes in domestic or commercial settings. Objects to be washed in a dishwasher can include dinnerware, flatware, pots and pans, cutlery, flatware, glasses, kitchenware, serving pans, trays, and the like. Such objects can be placed in a dishwasher rack in the dishwasher. The “dishwasher rack” (also known as warewashing rack) can include any rack that is used in a dishwasher for holding any objects to be washed. Unless noted otherwise, a “rack” in the present disclosure refers to a dishwasher rack. The rack can be a built-in part of the dishwasher or a removable accessory suitable for use in the dishwasher. The rack can be a peg rack or an open rack and can have any size and shape suitable for the dishwasher. Each dishwasher can include one or more built-in racks and/or can host one or more removable racks.

As used in the present disclosure, a “cleaning cycle” of the dishwasher can include various operational periods, such as one or more of a descaling period, a washing period, a rinsing period, and a drying period, depending on the availability of respective operational modes in the dishwasher and settings entered by a user of the dishwasher. “Cleaning” can include cleaning only, sanitizing only, cleaning and sanitizing, descaling and cleaning, or descaling, cleaning, and sanitizing. A “descaling period” includes a period or operational mode that is intended for a descaling liquid formed by water and a descaler to be applied to the objects being cleaned. A “washing period” includes a period or operational mode that is intended for a washing liquid formed by water and a detergent to be applied to the objects being washed. A “rinsing period” includes a period or operational mode that is intended for water, or a rinsing liquid formed by water and a rinse aid and/or a sanitizer, to be applied to the objects being cleaned. Some dishwashers (e.g., commercial dishwashers) may include a rinsing period that is primarily for sanitizing through heat and/or chemical means. The descaler, detergent, rinsing aid, and sanitizer can each be a chemical agent or a mixture of chemical agents in liquid or solid form. A “drying period” includes a period or operational mode that is intended for the cleaned objects to be dried by air flow and/or heat, without additional water and/or chemical agent applied.

In recent years, many commercial dishwashing machine providers have increasingly utilized lease contracts when supplying dishwashing machines to chain restaurants, catering enterprises, or other commercial customers. As such, the overall reliability and ease of serviceability of a dishwashing machine are important considerations for dishwashing machine suppliers in selecting dishwashing machines for future leasing. However, in many existing dishwashing machines, the subsystem adapted for maintaining fluid levels within a tank for holding dishes can be a source of significant problems and expense.

First, for example, many dishwashing machines utilize float level switches or pneumatic level switches positioned within the tank to generate an electrical signal based on the level of fluid in the tank; and some float level switches or pneumatic level switches level switches can be difficult and time-consuming to replace. Second, both float switches and pneumatic switches can be susceptible to various failure modes, which can lead to relatively frequent replacement. For example, float level switches can be prone to sticking or mechanical failures, such as due to material fatigue caused by continuous movement of the float over time, or material deterioration due to environment conditions within the tank, which can include high ambient temperatures and contact with acidic fluids, alkaline fluids, or oils. And, pneumatic level switches can prone to operational failures caused air leaks, as a drop in air pressure, such as caused by material deterioration of seals within the pneumatic level switch, seals within various piping connections, or deterioration of piping itself, can prevent the pneumatic level switch from operating correctly. In view of the above, an improved system for fluid level monitoring in dishwashing machines is desirable.

The systems and methods disclosed herein can provide solutions to the technical problems identified above, among others, such as by providing a fluid level monitoring system including a probe including a first electrode adapted to sense a first fluid (e.g., a lowermost or minimum fluid level) level in a tank of a dishwashing machine and a second electrode adapted to sense a second fluid level (e.g., an uppermost or maximum fluid level) in the tank of the dishwashing machine. The fluid level monitoring system can utilize the tank of the dishwashing machine as an electrical ground against which electrical signals (e.g., resistance values) from the first electrode and the second electrode can be referenced; and a control circuit adapted to process the electrical signals from the first electrode and the second electrode, such as to enable a control system, control circuit, or one or more application circuits of the dishwashing machine to perform various operations to ensure a fluid level within the tank remain between an uppermost or maximum level, and a lowermost or minimum level, during a cleaning cycle.

In view of the above, the fluid level monitoring system can reduce the overall cost of maintaining commercial dishwashing machines for dishwashing machine suppliers and improve the service capacity of dishwashing machine service providers. For example, as the probe can sense when a fluid level within a tank of a dishwashing machine is at a first level or a second level without utilizing any movable components, or requiring any seals or piping susceptible to damage from high temperatures, oils, or acidic or alkaline fluids, the probe can be highly resistant to mechanical failure and material degradation over time. Moreover, the probe can more accurately or more precisely measure a fluid level within a tank by eliminating measurement errors caused by sticking or incomplete actuation of a movable component.

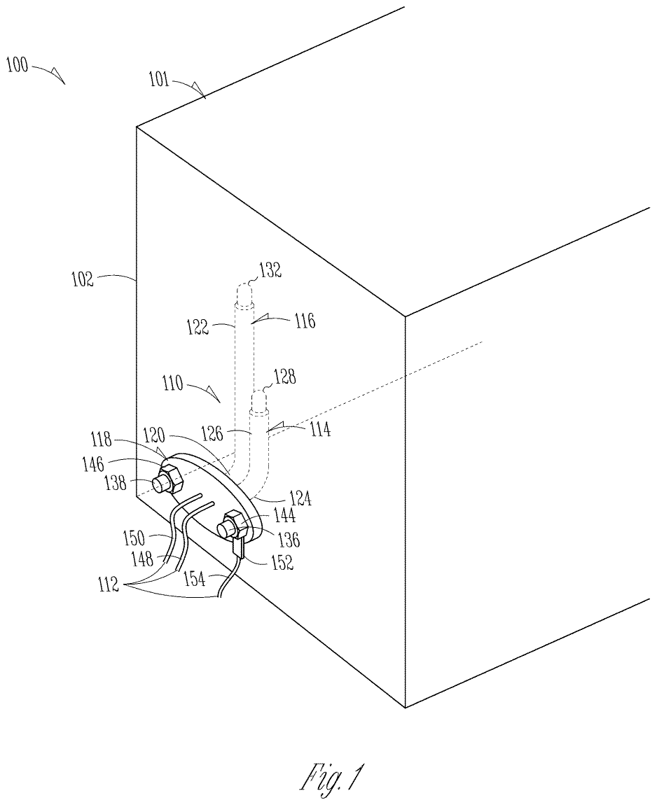

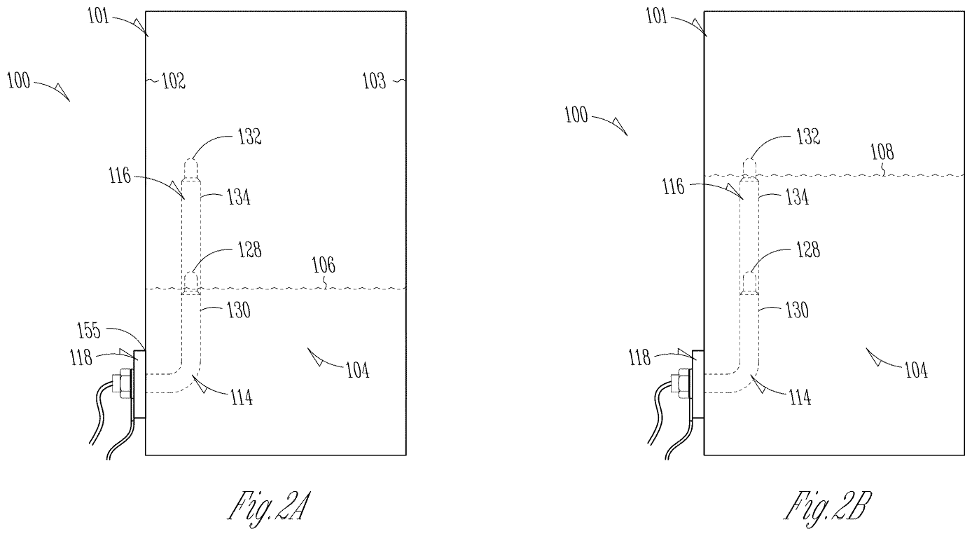

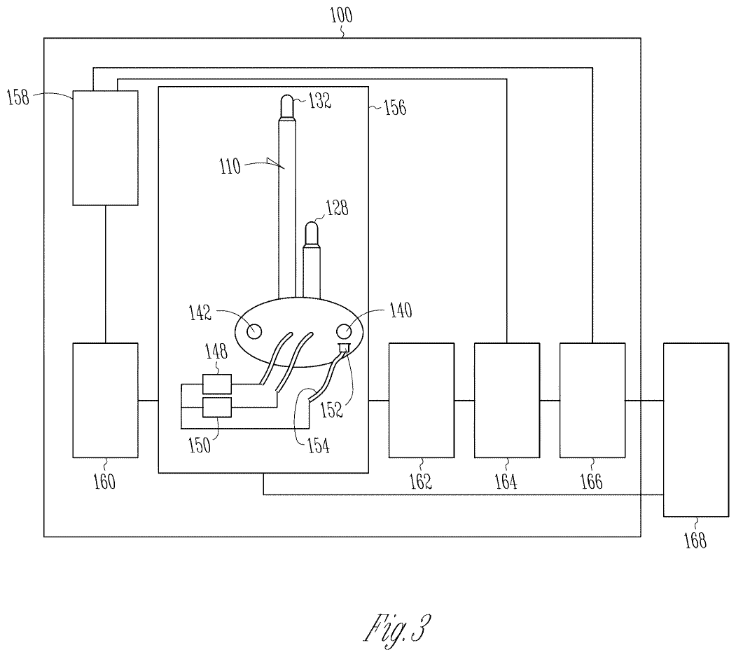

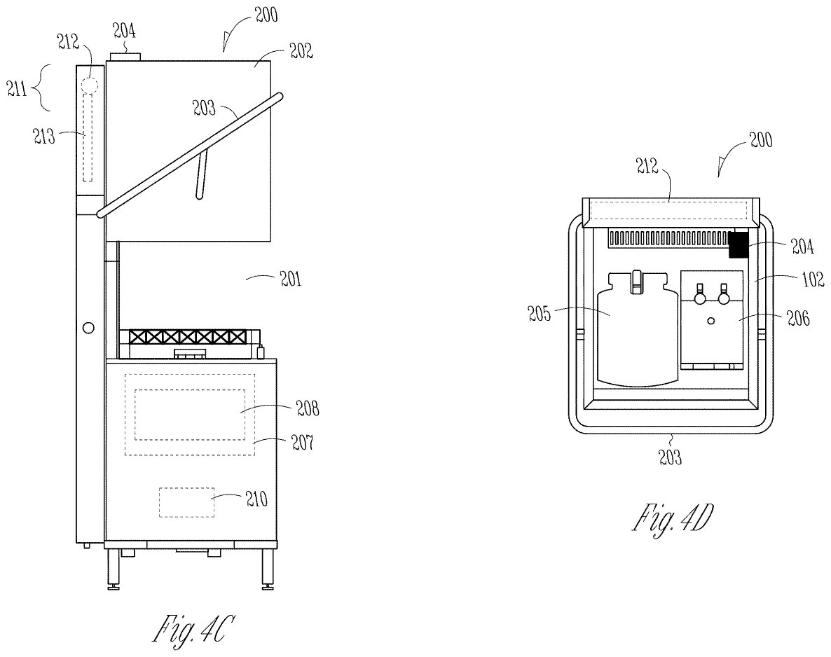

FIG. 1 illustrates a perspective view of a fluid level monitoring system 100. FIG. 2A illustrates a side view of a tank 101 holding a fluid 104 at a first level 106. FIG. 2B illustrates a side view of a tank 101 holding a fluid 104 at a second level 108. FIGS. 1-2B are discussed below concurrently. The tank 101 can generally be a reservoir or other area within a dishwashing machine adapted to hold the fluid 104 (FIGS. 2A-2B), such as during a cleaning cycle. In some examples, the tank 101 can be or otherwise represent any of a wash chamber 201 (FIGS. 4A-4C), a wash tank 208 (FIGS. 4A-4C), a wastewater tank 209 (FIG. 4A), or a booster tank 210 (FIGS. 4A-4C & 5) of a dishwashing machine 200, or a hydraulic system 229 thereof, shown in and described with regard to, one or more of FIGS. 4A-6 below. The tank 101 can be made from metal, such as, but not limited to, stainless steel or other conductive materials. In some examples, the tank 101 can include a first vertical wall 102 (FIGS. 2A-2B) and a second vertical wall 103 (FIGS. 2A-2B). The fluid 104 can generally be a fluid used during a cleaning cycle, such as, but not limited to, water including a detergent, oils, or other chemicals, minerals, or materials. In some examples, the fluid 104 can be any of the “clean water”, “wastewater”, or “drain water” described with regard to any of FIGS. 4A-6 below.

The fluid level monitoring system 100 can include a probe 110. In FIGS. 1-2B, the probe 110 is shown in shadow. The probe 110 can include a first conductor 114, a second conductor 116, and a mounting flange 118. The first conductor 114 and the second conductor 116 can extend outwardly from the mounting flange 118. In some examples, the probe 110 can be of unitary construction. For example, the first conductor 114 and the second conductor 116 can be formed integrally with the mounting flange 118, such help make the probe 110 convenient to replace and more economical to produce. The first conductor 114 can include a first lateral portion 120 (FIG. 1) and a first longitudinal portion 122 (FIG. 1); and the second conductor 116 can include a second lateral portion 124 (FIG. 1) and a second longitudinal portion 126 (FIG. 1). The first lateral portion 120 and the second lateral portion 124 can extend orthogonally to the mounting flange 118, and to the first longitudinal portion 122 and the second longitudinal portion 126.

The mounting flange 118, the first longitudinal portion 122, and the second longitudinal portion 126 can extend parallel to, and laterally offset from, the first vertical wall 102 or the second vertical wall 103 of the tank 101. In view of the above, the first conductor 114 and the second conductor 116 can form or define a substantially L-shaped cross-section. The first conductor 114 can also include a first electrode 128 and a first insulating jacket 130 (FIGS. 2A-2B); and the second conductor 116 can include a second electrode 132 and a second insulating jacket 134 (FIGS. 2A-2B). The first electrode 128 and the second electrode 132 can generally be exposed conductive tips or distal ends of a conductive core of the first conductor 114 and the second conductor 116, respectively.

The first insulating jacket 130 and the second insulating jacket 134 can be made from a non-conductive and hydrophobic material, such as, but not limited to, nylon. The first insulating jacket 130 can circumferentially encompass the first conductor 114 between the mounting flange 118 and the first electrode 128; and the second insulating jacket 134 can circumferentially encompass the second conductor 116 between the mounting flange 118 and the second electrode 132. The first insulating jacket 130 and the second insulating jacket 134 can thereby prevent any portion of a conductive core of the first conductor 114 or the second conductor 116 from contacting the fluid 104.

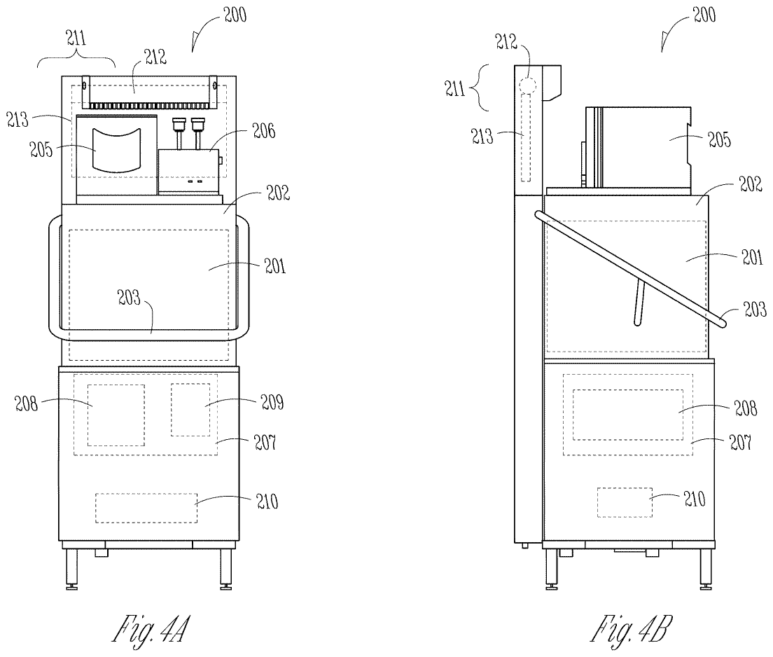

The mounting flange 118 can be configured to define various three-dimensional shapes, such as but not limited to, an ellipsoidal, cuboidal, or rectangular shaped body. The mounting flange 118 can be adapted to be secured to the first vertical wall 102 or the second vertical wall 103 of the tank 101, such as by corresponding to one or more fastening devices or means of the tank 101. For example, the first vertical wall 102 or the second vertical wall 103 of the tank 101 can include a first stud 136 (FIG. 1) and a second stud 138 (FIG. 1); and the mounting flange 118 can define a first bore 140 (FIG. 3) and a second bore 142 (FIG. 3). The first bore 140 and the second bore can be sized and shape to contact and receive the first stud 136 and the second stud 138, respectively, to support the probe 110 on, or otherwise in a position relative to, the tank 101. In one or more such examples, the first stud 136 and the second stud 138 can be threaded, such as to threadedly engage a first nut 144 (FIG. 1) and a second nut 146 (FIG. 1), respectively, to compressively clamp the mounting flange 118 against the tank 101.

In some examples, the probe 110 can enable some dishwashing machines to be converted from a pneumatic level sensing system to a conductive level sensing system. In such examples, the probe 110 can be adapted to replace a commercially available pneumatic level switch, one or more types or models of pneumatic level switches in widespread use in a dishwashing machine. For example, the mounting flange 118 can be similar to the size and shape of a mounting flange of, and can define similar mounting features such as, but not limited to, one or more bores adapted to receive a fastener such as a bolt, screw, or rivet therein, or one or more areas for engaging with other fastener means, such as a clips or hooks, of a commercially available dishwashing machine include a pneumatic level switch. This can enable the probe 110 to occupy the space of a pre-existing pneumatic level switch, and enable the probe 110 to be coupled to such a dishwashing machine using existing fastening or coupling means, to allow probe 110 to be quickly installed in an existing dishwashing machine without, or with minimal modification thereto.

The first level 106 can generally represent a lowermost, or minimum, amount of fluid within the tank 101 for a cleaning cycle, and the second level 108 can generally represent an uppermost, or maximum, amount of fluid within the tank 101 for a cleaning cycle. When the mounting flange 118 is secured to the tank 101, the first electrode 128 can be positioned within the tank 101 to sense when the fluid 104 is at the first level 106 and the second electrode 132 can be positioned within the tank 101 to sense when the fluid 104 is at the second level 108. The probe 110 can be adapted to allow a dishwashing machine to sense when the fluid 104 is at the first level 106 (FIG. 2A) or the second level 108 (FIG. 2B). For example, the first conductor 114 can include, or be coupled to, a first lead 148 (FIG. 1) and the second conductor 116 can include, or be coupled to, a second lead 150 (FIG. 1). The first lead 148 can thereby be in conductively connected to the first electrode 128; and the second lead 150 can thereby be conductively connected to the second electrode 132.

The first lead 148 and the second lead 150 can be conductively connected to a voltage or power source of a control circuit 112, such as a power supply 158 (FIG. 3).

The fluid level monitoring system 100 can further include a conductive gasket 152 (FIG. 1) and a third lead 154 (FIG. 1). The conductive gasket 152 can be conductively connected to the tank 101, such as through, not limited to, the first stud 136 extending from the first vertical wall 102. The conductive gasket 152 can also be conductively connected to the third lead 154, which, in turn, can be conductively connected to the control circuit 112 to thereby enable the tank 101 to serve as an electrical ground against which electrical signals (e.g., resistance values) from the first electrode 128 and the second electrode 132 can be referenced by the control circuit 112.

Additionally, in some examples, the probe 110 can be adapted to interface with a control system or one or more application circuits of a commercially available dishwashing machine. For example, the first lead 148, the second lead 150, and the third lead 154 can include connectors configured to engage with corresponding connectors of such a dishwashing machine to thereby reduce the amount of time and effort required to establish electrical communication between the probe 110 and a control system or one or more application circuits of the dishwashing machine.

In some examples, the fluid level monitoring system 100 can also include a first sealing element 155 (FIG. 2A). The first sealing element 155 can be for example, but not limited to, an elastomeric or polymeric gasket, or a sealing material deposited on one, or both, of the mounting flange 118, or the first vertical wall 102. The first sealing element 155 can then be compressively clamped between the mounting flange 118 and the first vertical wall 102 to thereby establish a fluid tight seal between the tank 101 and the probe 110.

In the operation of some examples, a pump of a dishwashing machine can begin pumping the fluid 104 into the tank 101, such as at the direction of a control system or application circuit thereof. The control circuit 112 can energize the first electrode 128 and the second electrode 132 by causing an alternating current (“AC”) electrical signal to be applied thereto, such as to obtain an electrical signal from the first electrode 128 and the second electrode 132. When the fluid 104 within the tank 101 is below the first level 106, the electrical signal can be a high or infinite resistance value. Eventually, the fluid 104 can reach the first level 106 and submerge the first electrode 128 thereunder, which can complete a circuit between the probe 110 and the tank 101. For example, the fluid 104 can act as an electrolyte between the first electrode 128 and the first vertical wall 102, enabling current to return from the first electrode 128 to the control circuit 112 via the first vertical wall 102, the conductive gasket 152, and the third lead 154. When the fluid 104 within the tank 101 is above the first level 106, the electrical signal can be a relatively low resistance value.

The control circuit 112 can then identify or recognize the drop or change in the resistance value obtained from at the first electrode 128. In some examples, the pump of the dishwashing machine can continue pumping the fluid 104 into the tank 101, such as at the direction of a control system or application circuit thereof, until the fluid 104 reaches the second level 108 and the second electrode 132 is submerged thereunder, which can complete a circuit between the probe 110 and the tank 101; and enable current to return from the second electrode 132 to the control circuit 112 via the first vertical wall 102, the conductive gasket 152, and the third lead 154. In this way, the control circuit 112 can monitor when the fluid 104 reaches the first level 106 or the second level 108. In turn, the control circuit 112 can process the electrical signals to enable the dishwashing machine to perform various operations, such as to activate a pump to cause the fluid 104 to be pumped into the tank 101, or to active a pump or valve to cause the fluid 104 to be drained from the tank 101, during a cleaning cycle. For example,

[symbol]

FIG. 3. illustrates a schematic diagram of an example fluid level monitoring system 100. The probe 110, such as including the first electrode 128, the second electrode 132, the first lead 148, and the second lead 150, and the conductive gasket 152 and the third lead 154, can collectively form a probe circuit 156 adapted to sense the electrical resistance between the tank 101 (FIGS. 1-2B) and the first electrode 128 or the second electrode 132. The control circuit 112 shown in, and discussed with regard to FIG. 1 above, can include or be at least partially realized by a power supply 158, an excitation circuit 160, an acquisition circuit 162, a conversion circuit 164, and an indication circuit 166. The power supply 158 can be adapted to provide voltage, such as in the form of direct current, to the fluid level monitoring system 100. For example, the power supply 158 can be electrically connected to any of the probe circuit 156, the excitation circuit 160, the acquisition circuit 162, the conversion circuit 164, or the indication circuit 166. In one or more examples, the power supply 158 can be, but is not limited to, a direct current transformer.

The excitation circuit 160 can be adapted to receive direct current from the power supply 158; and convert the direct current into alternating current. For example, the excitation circuit 160 can be, but is not limited to, a direct current to alternating converter. The excitation circuit 160 can be adapted to provide alternating current to the first electrode 128 and the second electrode 132 of the probe 110. For example, the excitation circuit 160 can be electrically connected to the first lead 148 and the second lead 150. In some examples, the alternating current provided to the probe 110 can be of symmetric oscillation with respect to the first electrode 128 and the second electrode 132, such as to avoid polarization of the fluid 104 (FIGS. 2A-2B) or ion aggregation about the first electrode 128 or the second electrode 132. Additionally, the alternative current can be of relatively low voltage, such as below the electrolysis threshold for water (~1.1 Volts).

The acquisition circuit 162 can be adapted to receive and capture alternating current electrical signals, in the form of resistance values, measured between the first electrode 128 and the tank 101, and the second electrode 132 and the tank 101, of the probe circuit 156. The acquisition circuit 162 also be adapted to processes the alternating current electrical signals into signals recognizable or otherwise usable by the conversion circuit 164. The conversion circuit 164 can be adapted to receive the alternating current electrical signals processed by the acquisition circuit 162; and translate the processed alternating current electrical signals back into direct current signals recognizable or otherwise usable by the indication circuit 166. For example, the conversion circuit 164 can be, or can otherwise include, an alternating current to direct current rectifier.

The indication circuit 166 can be adapted to receive the direct electrical signals from the conversion circuit 164 and determine whether the fluid 104 is in contact with the first electrode 128 or the second electrode 132. For example, based on a value of one or more signals from the conversion circuit 164, the indication circuit 166 can output a 0 or 1 value or signal representing no fluid contact with the first electrode 128 or the second electrode 132, or fluid contact with the first electrode 128 or the second electrode 132, respectively, to an application circuit 168 of a dishwashing machine such as to cause, or otherwise enable, other components of a dishwashing machine to perform various functions. For example, such values or signals can cause electrical relays, pumps, switches, solenoid valves to be activated by the application circuit 168 to, in turn, cause the fluid 104 to be pumped into the tank 101, to be drained from the tank 101.

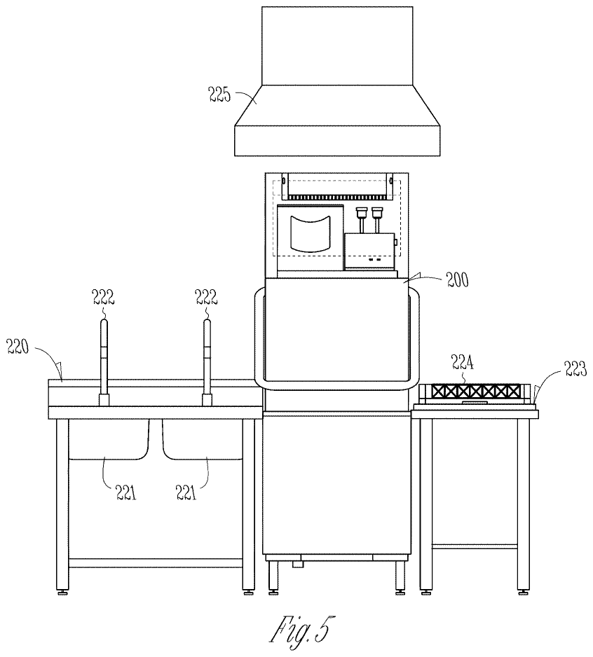

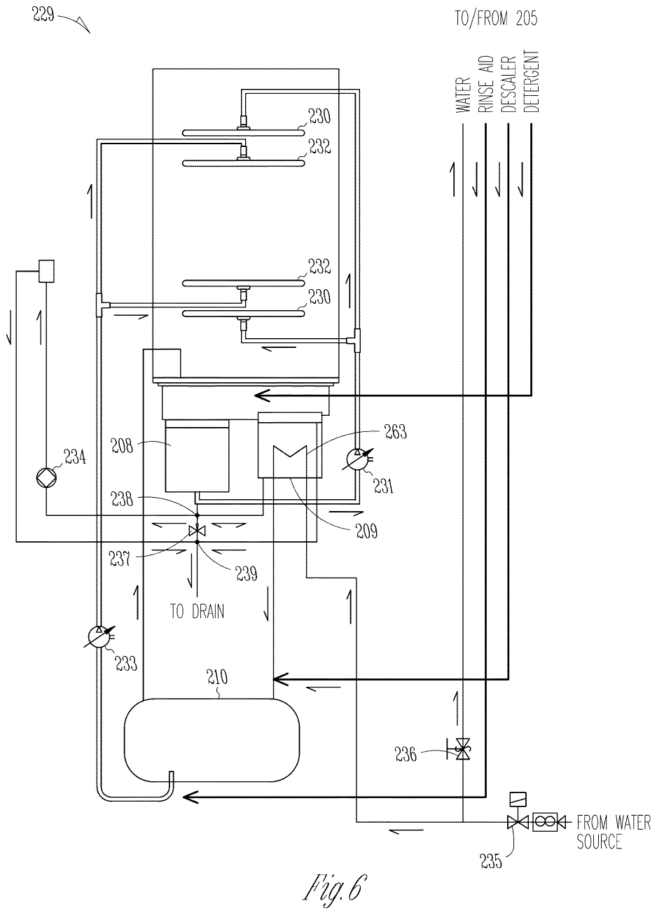

In some examples, in respond to such values or singles, the application circuit 168 can cause a rinse pump 233 (FIG. 6) of the dishwashing machine 200 (FIGS. 4A-5) to activate, or remain active, until the fluid 104 reaches the first level 106 or the second level 108 within a tank of reservoir of the dishwashing machine 200 such as, but not limited to, the wash chamber 201 (FIGS. 4A-4C), the wash tank 208 (FIGS. 4A-4C), the wastewater tank 209 (FIG. 4A), or the booster tank 210 (FIGS. 4A-4C & 5). In another example, in respond to such values or singles, the application circuit 168 can cause a drain pump 234 (FIG. 6) of the dishwashing machine 200 to activate, or remain active, until the fluid 104 reaches the first level 106 or the second level 108 within a tank of reservoir of the dishwashing machine 200 such as, but not limited to, the wash chamber 201 (FIGS. 4A-4C), the wash tank 208 (FIGS. 4A-4C), the wastewater tank 209 (FIG. 4A), or the booster tank 210 (FIGS. 4A-4C & 5).

The application circuit 168 can generally represent a portion of, or an entire, control system of a dishwashing machine, such as including a controller board, a microprocessor, or other electronic components. The indication circuit 166 or the application circuit 168 may also include an audible alarm, a display, or other features adapted to inform a user of a level of the fluid 104 within the tank 101. In view of the above, the fluid level monitoring system 100, together with the application circuit 168, can implement conductive fluid level sensing in dishwashing machines, which can help to reduce the overall cost of maintaining dishwashing machines for dishwashing machine suppliers, improve the service capacity of dishwashing machine service providers, and improve the accuracy and consistency of a level sensing system within a dishwashing machine.

FIGS. 4A-4D illustrate various views of an example dishwashing machine 200 in which the fluid level monitoring system 100 of FIGS. 1-3 can be used. FIG. 4A illustrates a front view of the dishwashing machine 200 when a hood 202 is closed, FIG. 4B illustrates a side view with a hood 202 of the dishwashing machine 200 closed, FIG. 4C illustrates a side view of the dishwashing machine 200 with the hood 202 open, and FIG. 4D illustrates a top view of the dishwashing machine 200. FIGS. 4A-4B are discussed below concurrently.

The dishwashing machine 200 is discussed below for illustrative but not restrictive purposes. The dishwashing machine 200 can be a hood-type dishwasher that includes the hood 202 to cover a wash chamber 201. The dishwashing machine 200 can include a hood lifting handle 203. The hood lifting handle 203 can be elevated by a user to open the hood 202 for loading objects to be washed into the wash chamber 201 before a cleaning cycle, lowered by the user to close the hood 202 to cover the wash chamber 201 before starting the cleaning cycle, and elevated by the user to open the hood 202 for unloading the cleaned objects after the cleaning cycle is completed. A hood lock 204 can be installed on the hood 202. The hood lock 204 can be automatically locked when a cleaning cycle starts to prevent the hood 202 from being accidentally opened during the cleaning cycle.

The dishwashing machine 200 can include a dispenser 205 that contains various chemical agents for dispensing during different periods of the cleaning cycle. Each chemical agent may be in liquid or solid form, and the dispenser 205 can be configured to accommodate liquid and/or solid forms for each chemical agent, depending on the form(s) of the chemical agent that is available and intended to use. Each chemical agent in the dispenser 205 can be refillable. In one example, such as during a cleaning cycle, the dishwashing machine 200 can perform cycles including a descaling period, a washing period, and a rinsing period. The dispenser 205 can be an integrated dispenser that can contain a descaler, a detergent, and a rinse aid; and can dispense the descaler for use during the descaling period, the detergent for use during the washing period, and the rinse aid for use during the rinsing period.

The dishwashing machine 200 can include a user interface 206. The user interface 206 can be adapted to visually and/or audibly indicate an operational status, and allow a user to control various operations of, the dishwashing machine 200. The user interface 206 can include a display screen, such as a touchscreen that can display an operation status of the dishwashing machine 200, and receive commands and other information from the user. The user interface 206 can include a power switch for the user to turn the electrical power for the dishwashing machine 200 on and off. The user interface 206 can allow the user to start cleaning cycle, optionally after indicating to the user that the cleaning cycle is ready to start (e.g., after the hood 202 is closed).

In one example, the user interface 206 can allow the user to select which period(s) to include in the cleaning cycle. In one example, the user may select only the rinsing period when, for example, dishes are known to be clean but need disinfection or sterilization. In one example, the user can select the washing and rinsing periods only when a need for descaling dishes is not indicated. In one example, the user interface 206 can be configured (e.g., programmed) for following a hygiene procedure and/or complying with a regulation for ensuring food safety. The dishwashing machine 200 can provide high space and power efficiency to lower operational cost and/or allowing a food service establishment to operate under limited space and/or electrical power capacity. For example, the dishwashing machine 200 can include an internal wastewater recycling system 207 and an internal steam reduction system 211 to recover thermal energy resulting from the operations during each cleaning cycle for heating clean water to be used in the operations.

The internal wastewater recycling system 207 can include the wash tank 208 (also known as main wash tank) to recycle a hot washing liquid to be sprayed into, and returning from, the wash chamber 201 during the washing period, and the wastewater tank 209 (also known as overflow tank) to receive excessive hot washing liquid from wash tank 208 as wastewater. A heat exchange module is placed in the wastewater tank 209 to heat clean water while cooling the wastewater before it is discharged to a drain (e.g., a drain connected to the sewage of the building). The heated clean water is to be added to wash the wash tank 208 and a booster tank 210 (also known as rinse tank) as needed. In the illustrated example, the booster tank 210 receives the clean water and the descaler to form a descaling liquid to be sprayed into the wash chamber 201 during the descaling period and receives the clean water and the rinse aid to form a rinsing liquid to be sprayed into the wash chamber 201 during the rinsing period. The internal steam reduction system 211 can include a fan 212. The fan 212 can draw steam from the wash chamber 201 and a condenser 213 positioned in the steam path to condense the steam while heating the clean water (in addition to the heat recovery from the wastewater). The fan 212 can blow the remaining steam out of dishwashing machine 200.

The dishwashing machine 200 can be sized to allow for easy operation and maintenance by a user having a height of 150 cm or taller. A force required to open the hood 202 by elevating the hood lifting handle 203 can be around 3.5 kg or lighter. In one example, the wash tank 208 can have a capacity of about 24 L, the wastewater tank 209 can have a capacity of about 12 L, and the booster tank 210 can have a capacity of about 10 L.

FIG. 5 illustrates an example of the dishwashing machine 200 of FIGS. 4A-4B with accessories. Such accessories can include, but are not limited to, a dirty dish stand 220, a clean dish stand 223, a dishwasher rack 224, and a vent hood 225. The dirty dish stand 220 can include one or more sinks 221 and one or more faucets 222. When necessary or convenient, dishes and/or other objects to be cleaned can be placed in the one or more sinks 221 and pre-washed using water from the one or more faucets 222 before being loaded into the wash chamber 201 (FIGS. 4A-4C) when the hood 202 (FIGS. 4A-4D) is open. The dishwasher rack 224 can be placed in the wash chamber 201 when empty, and the dishes and/or other objects can be placed into dishwasher rack 224 for each cleaning cycle. After the cleaning cycle is completed, the dishwasher rack 224 can be loaded with cleaned dishes and/or other objects can be removed from wash chamber 201 (with the hood 202 open) and placed on the clean dish stand 223 before use and/or further distribution. The vent hood 225 can vent the steam blown out of dishwashing machine 200 by a fan to outside of the building in which dishwashing machine 200 is placed.

FIG. 6 illustrates an example hydraulic system of the dishwashing machine 200 of FIGS. 4A-5. The hydraulic system 229 can support liquid movement functions during the descaling period, the washing period, and the rinsing period. The hydraulic system 229 includes a main water valve 235 (e.g., an electromagnetically controlled valve) that can be opened to receive clean water from a water source (e.g., a water main of the building). The clean water can be heated in the wastewater tank 209 and then routed to the wash tank 208 and the booster tank 210. The clean water can also be routed to the dispenser 205, when needed (e.g., for dissolving one or more chemical agents in solid form(s)), through a dispenser valve 236.

During the descaling period, the descaler is dispensed from the dispenser 205 into the booster tank 210 to form the descaling liquid with the heated clean water in booster tank 210. The descaling liquid can be pumped by a rinse pump 233 to rinse arms 230. The rinse arms 230 can be positioned above and under the wash chamber 201 and rotated to spray the scaling liquid into the wash chamber 201 from above and under. The descaling liquid can flow into the wash tank 208 after passing through the wash chamber 201.

During the washing period, the detergent is dispensed from the dispenser 205 into the wash tank 208 to form the washing liquid with the heated clean water in the wash tank 208. The washing liquid is pumped by a wash pump 231 to wash arms 232. The wash arms 232 are positioned above and under the wash chamber 201 and rotated to spray the washing liquid into the wash chamber 201 from above and under. The washing liquid returns to the wash tank 208 after passing through the wash chamber 201.

During the rinsing period, the rinse aid is dispensed from the dispenser 205 into the booster tank 210 to form the rinsing liquid with the heated clean water in booster tank 210. The rinsing liquid is pumped by the rinse pump 233 to the rinse arms 230. The rinse arms 230 are rotated to spray the rinsing liquid into the wash chamber 201 from above and under. The rinsing liquid flows into the wash tank 208 after passing through the wash chamber 201.

Thus, wash tank 208 collects all the liquid sprayed into wash chamber 201. When the level of the liquid in the wash tank 208 exceeds a set threshold, the excessive liquid flows into the wastewater tank 209 as the wastewater. In an example, as illustrated in FIG. 6, the hydraulic system 229 includes a wastewater recycling system that includes a drain valve 237 and two watertight or waterproof seals 238 and 239 to separate the wastewater from drain water (which is the wastewater ready to be discharged from dishwashing machine 200 to the drain. A drain pump 234 pumps the drain water out of the wastewater recycling system to the drain. When the drain pump 234 is turned off and the drain valve 237 is closed, the wastewater flows out of the wash tank 208 into the wastewater tank 209, and then flows out of the wastewater tank 209 and turns into the drain at the waterproof seal 239. When the drain pump 234 is turned on and the drain valve 237 is closed, the wastewater flows out of the wastewater tank 209 (as being pumped) through the path including the drain pump 234 and turns into the drain at the waterproof seal 239.

When drain valve 237 is open, the wastewater flows from wash tank to the drain directly (without flowing through the wastewater tank 209 or the drain pump 234. A heat exchange coil 263 can be placed in the wastewater tank 209. The clean water flows through heat exchange coil 263 to be heated by the wastewater before being routed into the wash tank 208 or the booster tank 210, while the wastewater is cooled by the clean water before being discharged to the drain.

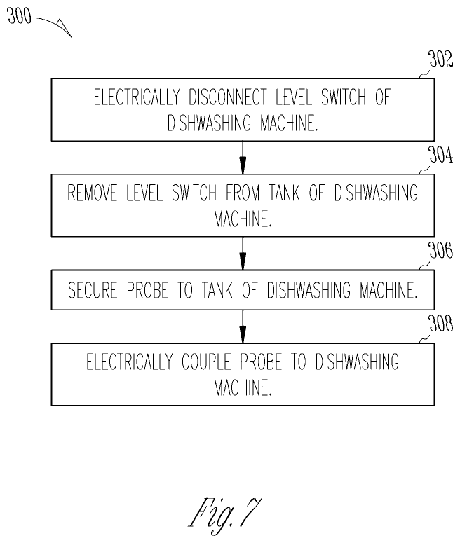

FIG. 7 illustrates a method 300 of replacing a level switch of a dishwashing machine. The steps or operations of the method 300 are illustrated in a particular order for convenience and clarity; many of the discussed operations can be performed by multiple different actors, devices, or systems. It is understood that subsets of the operations discussed in the method 300 can be attributable to a single actor, device, or system and can be considered a separate standalone process or method.

The method 300 can include operation 302. The operation 302 can include electrically disconnecting the level switch of the dishwashing machine. For example, a user can disconnect the level switch from a control system, control circuit, application circuit, or wiring harness of the dishwashing machine, such as after determining that the level switch is non-function or is otherwise in need of replacement.

The method 300 can include operation 304. The operation 304 can include removing the level switch from a tank of the dishwashing machine, wherein removing the level switch includes removing one or more fasteners. For example, a user can remove at least one nut from at least one stud extending outwardly from the tank of the dishwashing machine and slide the level switch off of the at least one stud. The method 300 can include operation 306. The operation 306 can include securing a probe to the tank of the dishwashing machine, wherein securing the probe to the tank includes reinstalling the one or more fasteners. For example, insert the at least one stud through at least one bore of the probe, and re-secure the at least one nut to the at least one stud to compressively clamp a mounting flange of the probe against the tank.

In some examples, the operation 306 can include positioning at least one conductive gasket on the at least one stud, the at least one conductive gasket adapted to provide an electrical ground to a control circuit. For example, such as before the user inserts the at least one stud through at least one bore of the probe, the user can position the at least one conductive gasket on the at least one stud to establish conductive communication between the tank and a wire or lead connected to the least one conductive gasket. In some examples, the operation 306 can include establishing a fluid tight seal between a wall of the tank and a mounting flange of the probe. For example, such as before the user inserts the at least one stud through at least one bore of the probe, the user can position a sealing element on the at least one stud; or apply a sealing material to a mounting flange of the probe or to a surface of the tank in a location proximal to the at least one stud.

The method 300 can include operation 308. The operation 308 can include electrically coupling the probe to the dishwashing machine. For example, a user can connect the probe and a conductive gasket in conductive contact with the tank to a control circuit of a fluid level monitoring system, or to a wiring harness or application circuit of a dishwashing machine, to thereby enable the dishwashing machine to conductively sense a fluid level within the tank during a cleaning cycle.

The foregoing systems and devices, etc. are merely illustrative of the components, interconnections, communications, functions, etc. that can be employed in carrying out examples in accordance with this disclosure. Different types and combinations of sensor or other portable electronics devices, computers including clients and servers, implants, and other systems and devices can be employed in examples according to this disclosure.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided.

Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure.

This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

### Notes and Examples

The following, non-limiting examples, detail certain aspects of the present subject matter to solve the challenges and provide the benefits discussed herein, among others.

Example 1 is a probe for conductively sensing a water level within a tank of a dishwashing machine, the probe comprising: a mounting flange adapted to be secured the tank of the dishwashing machine; a first conductor extending outwardly from the mounting flange, the first conductor including a first electrode, wherein the first electrode is adapted to sense a first fluid level in the tank; and a second conductor extending outwardly from the mounting flange, the second conductor including a second electrode, wherein the second electrode is adapted to sense a second fluid level in the tank that is greater than the first fluid level.

In Example 2, the subject matter of Example 1 includes, wherein the mounting flange defines a first bore and a second bore spaced laterally apart from the first bore, wherein the first bore is adapted to receive a first stud of the dishwashing machine and the second bore is adapted to receive a second stud of the dishwashing machine.

In Example 3, the subject matter of Example 2 includes, wherein the first conductor and the second conductor each define a substantially L-shaped cross-section.

In Example 4, the subject matter of Example 3 includes, wherein: the first conductor includes a first lateral portion and a first longitudinal portion, the first lateral portion extending orthogonally to the mounting flange and the first longitudinal portion extending parallel to and laterally offset from a first vertical wall or a second vertical wall of the tank; and the second conductor includes a second lateral portion and a second longitudinal portion, the second lateral portion extending orthogonally to the mounting flange and the second longitudinal portion extending parallel to and laterally offset from the first vertical wall or the second vertical wall of the tank.

In Example 5, the subject matter of Example 4 includes, wherein the first lateral portion and the first longitudinal portion extend parallel to, and laterally offset from, the second lateral portion and the second longitudinal portion, respectively.

In Example 6, the subject matter of Example 5 includes, wherein the first conductor includes a first insulating jacket circumferentially encompassing the first conductor between the mounting flange and the first electrode; and wherein the second conductor includes a second insulating jacket circumferentially encompassing the second conductor between the mounting flange and the second electrode.

In Example 7, the subject matter of Example 6 includes, wherein the first conductor includes a first lead extending transversely through the mounting flange; and wherein the second conductor includes a second lead extending transversely though the mounting flange.

In Example 8, the subject matter of Example 7 includes, wherein the mounting flange is sized and shaped to correspond to a mounting flange of a pneumatic level switch.

Example 9 is a fluid detection system for a dishwashing machine, the fluid detection system comprising: a tank adapted to hold a fluid during a cleaning cycle, the tank including a first vertical wall and a second vertical wall, wherein the tank is adapted to function as an electrical ground; a probe including: a mounting flange adapted to be secured to the first vertical wall or the second vertical wall of the tank of the dishwashing machine; a first conductor extending outwardly from the mounting flange into the tank, the first conductor including a first insulating jacket and a first electrode, wherein the first electrode is positioned to contact the fluid within the tank when the fluid is at a first fluid level; a second conductor extending outwardly from the mounting flange into the tank, the second conductor including a second insulating jacket and a second electrode, wherein the second electrode is positioned to contact the fluid within the tank when the fluid is at a second fluid level; and a control circuit adapted to provide alternating current to the first electrode and the second electrode, and, based on a signal from the first electrode or the second electrode, cause fluid to be pumped into the tank or to be drained from the tank during a cleaning cycle.

In Example 10, the subject matter of Example 9 includes, a conductive gasket secured to the mounting flange and in conductive communication with the tank, the conductive gasket adapted to provide an electrical ground signal to the control circuit.

In Example 11, the subject matter of Example 10 includes, wherein the probe includes a first sealing element adapted to establish a fluid tight seal between the tank and the mounting flange.

In Example 12, the subject matter of Examples 9-11 includes, wherein the first conductor and the second conductor each define a substantially L-shaped cross-section.

In Example 13, the subject matter of Example 12 includes, wherein the first conductor includes a first lateral portion and a first longitudinal portion, the first lateral portion extending orthogonally to the mounting flange and the first longitudinal portion extending parallel to and laterally offset from a first vertical or a second vertical wall of the tank; and the second conductor includes a second lateral portion and a second longitudinal portion, the second lateral portion extending orthogonally to the mounting flange and the second longitudinal portion extending parallel to and laterally offset from the first vertical wall or the second vertical wall of the tank.

In Example 14, the subject matter of Examples 9-13 includes, wherein the mounting flange is sized and shaped to correspond to a mounting flange of a pneumatic level switch.

In Example 15, the subject matter of Example 14 includes, wherein the mounting flange defines a first bore and a second bore spaced laterally apart from the first bore, wherein the first bore is adapted to receive a first stud of the dishwashing machine and the second bore is adapted to receive a second stud of the dishwashing machine.

In Example 16, the subject matter of Examples 9-15 includes, wherein the control circuit includes a power supply, an excitation circuit, a probe circuit, an acquisition circuit, a conversion circuit, and an indication circuit.

Example 17 is a method of replacing a level switch of a dishwashing machine, the method comprising: electrically disconnecting the level switch of the dishwashing machine; removing the level switch from a tank of the dishwashing machine, wherein removing the level switch includes, removing one or more fasteners; securing a probe to the tank of the dishwashing machine, wherein securing the probe to the tank includes reinstalling the one or more fasteners; and electrically coupling the probe to the dishwashing machine.

In Example 18, the subject matter of Example 17 includes, wherein removing the level switch includes removing at least one nut from at least one stud extending outwardly from the tank of the dishwashing machine; and wherein securing the probe to the tank of the dishwashing machine, wherein securing the probe to the tank includes inserting the at least one stud through the probe and securing the at least one nut to the at least one stud.

In Example 19, the subject matter of Example 18 includes, wherein electrically coupling the probe to dishwashing includes positioning at least one conductive gasket on the at least one stud, the at least one conductive gasket adapted to provide an electrical ground to a control circuit.

In Example 20, the subject matter of Examples 17-19 includes, wherein securing the probe to the tank includes establishing a fluid tight seal between a wall of the tank and a mounting flange of the probe.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A probe for conductively sensing a water level within a tank of a dishwashing machine, the probe comprising:
a mounting flange adapted to be secured the tank of the dishwashing machine;
a first conductor extending outwardly from the mounting flange, the first conductor including a first electrode, wherein the first electrode is adapted to sense a first fluid level in the tank; and
a second conductor extending outwardly from the mounting flange, the second conductor including a second electrode, wherein the second electrode is adapted to sense a second fluid level in the tank that is greater than the first fluid level.

2. The probe of claim 1, wherein the mounting flange defines a first bore and a second bore spaced laterally apart from the first bore, wherein the first bore is adapted to receive a first stud of the dishwashing machine and the second bore is adapted to receive a second stud of the dishwashing machine.

3. The probe of claim 2, wherein the first conductor and the second conductor each define a substantially L-shaped cross-section.

4. The probe of claim 3, wherein:
the first conductor includes a first lateral portion and a first longitudinal portion, the first lateral portion extending orthogonally to the mounting flange and the first longitudinal portion extending parallel to and laterally offset from a first vertical wall or a second vertical wall of the tank; and
the second conductor includes a second lateral portion and a second longitudinal portion, the second lateral portion extending orthogonally to the mounting flange and the second longitudinal portion extending parallel to and laterally offset from the first vertical wall or the second vertical wall of the tank.

5. The probe of claim 4, wherein the first lateral portion and the first longitudinal portion extend parallel to, and laterally offset from, the second lateral portion and the second longitudinal portion, respectively.

6. The probe of claim 5, wherein the first conductor includes a first insulating jacket circumferentially encompassing the first conductor between the mounting flange and the first electrode; and wherein the second conductor includes a second insulating jacket circumferentially encompassing the second conductor between the mounting flange and the second electrode.

7. The probe of claim 6, wherein the first conductor includes a first lead extending transversely through the mounting flange; and wherein the second conductor includes a second lead extending transversely though the mounting flange.

8. The probe of claim 7, wherein the mounting flange is sized and shaped to correspond to a mounting flange of a pneumatic level switch.

9. A fluid detection system for a dishwashing machine, the fluid detection system comprising:
a tank adapted to hold a fluid during a cleaning cycle, the tank including a first vertical wall and a second vertical wall, wherein the tank is adapted to function as an electrical ground;
a probe including:
a mounting flange adapted to be secured to the first vertical wall or the second vertical wall of the tank of the dishwashing machine;
a first conductor extending outwardly from the mounting flange into the tank, the first conductor including a first insulating jacket and a first electrode, wherein the first electrode is positioned to contact the fluid within the tank when the fluid is at a first fluid level;
a second conductor extending outwardly from the mounting flange into the tank, the second conductor including a second insulating jacket and a second electrode, wherein the second electrode is positioned to contact the fluid within the tank when the fluid is at a second fluid level; and
a control circuit adapted to provide alternating current to the first electrode and the second electrode, and, based on a signal from the first electrode or the second electrode, cause fluid to be pumped into the tank or to be drained from the tank during a cleaning cycle.

10. The system of claim 9, further comprising a conductive gasket secured to the mounting flange and in conductive communication with the tank, the conductive gasket adapted to provide an electrical ground signal to the control circuit.

11. The system of claim 10, wherein the probe includes a first sealing element adapted to establish a fluid tight seal between the tank and the mounting flange.

12. The system of claim 9, wherein the first conductor and the second conductor each define a substantially L-shaped cross-section.

13. The system of claim 12, wherein the first conductor includes a first lateral portion and a first longitudinal portion, the first lateral portion extending orthogonally to the mounting flange and the first longitudinal portion extending parallel to and laterally offset from a first vertical or a second vertical wall of the tank; and
the second conductor includes a second lateral portion and a second longitudinal portion, the second lateral portion extending orthogonally to the mounting flange and the second longitudinal portion extending parallel to and laterally offset from the first vertical wall or the second vertical wall of the tank.

14. The system of claim 9, wherein the mounting flange is sized and shaped to correspond to a mounting flange of a pneumatic level switch.

15. The system of claim 14, wherein the mounting flange defines a first bore and a second bore spaced laterally apart from the first bore, wherein the first bore is adapted to receive a first stud of the dishwashing machine and the second bore is adapted to receive a second stud of the dishwashing machine.

16. The system of claim 9, wherein the control circuit includes a power supply, an excitation circuit, a probe circuit, an acquisition circuit, a conversion circuit, and an indication circuit.

17. A method of replacing a level switch of a dishwashing machine, the method comprising:
electrically disconnecting the level switch of the dishwashing machine;
removing the level switch from a tank of the dishwashing machine, wherein removing the level switch includes removing one or more fasteners;
securing a probe to the tank of the dishwashing machine, wherein securing the probe to the tank includes reinstalling the one or more fasteners; and
electrically coupling the probe to the dishwashing machine.

18. The method of claim 17, wherein removing the level switch includes removing at least one nut from at least one stud extending outwardly from the tank of the dishwashing machine; and wherein securing the probe to the tank of the dishwashing machine, wherein securing the probe to the tank includes inserting the at least one stud through the probe and securing the at least one nut to the at least one stud.

19. The method of claim 18, wherein electrically coupling the probe to dishwashing includes positioning at least one conductive gasket on the at least one stud, the at least one conductive gasket adapted to provide an electrical ground to a control circuit.

20. The method of claim 17, wherein securing the probe to the tank includes establishing a fluid tight seal between a wall of the tank and a mounting flange of the probe.
